(19) United States
(12) Patent Application Publication
(10) Pub. No.: US 2024/0318447 A1
(43) Pub. Date: Sep. 26, 2024

(54) CLEAN WORK BOOTH WITH CEILING AND/OR WALL ACCESS

(71) Applicant: Clean Work Booth, Inc., Jacksonville, FL (US)

(72) Inventor: Kyle Bessent, Jacksonville, FL (US)

(21) Appl. No.: 18/587,859

(22) Filed: Feb. 26, 2024

Related U.S. Application Data
(60) Provisional application No. 63/487,054, filed on Feb. 27, 2023.

(51) Int. Cl. E04H 1/12; B08B 15/02

(52) U.S. Cl. CPC E04H 1/125; B08B 15/02

(57) ABSTRACT

A mobile clean room has a substantially rectangular frame having an upper and lower portion and is formed of a plurality of metal tube members and transparent plastic wall panels affixed to the frame to form an end wall and front and rear walls. A floor plate is affixed to the lower portion of the frame. A plurality of locking swivel wheels is affixed to the lower portion of the frame. A ladder is mounted between the floor plate and the upper portion of the frame. A dust guard assembly is attached to the top of the frame and is movably mounted. A door is pivotally mounted to the frame. One or more of both ceiling and/or wall accesses are provided.

### CROSS-REFERENCE TO RELATED APPLICATIONS

The present application claims priority to U.S. Provisional Patent Application No. 63/487,054 filed Feb. 27, 2023, the contents of which are incorporated herein by reference in their entirety.

### TECHNICAL FIELD

The present embodiments relate to clean rooms or booths and particularly to mobile clean rooms that interface with an area upon which work and cleaning will be accomplished.

### BACKGROUND

Clean rooms and associated technology are well known in the art. What is desired is a clean room with a movable portion that can provide a substantially airtight interface with, for example, a ceiling and/or wall, allowing ceiling tiles and/or wall material to be removed without exposing the surrounding area to dirt and debris that exists in the area above the ceiling and/or adjacent to a wall where maintenance work is to be performed. None of the clean rooms known to the prior art are satisfactory. While the inventions of U.S. Pat. No. 7,448,945 dramatically advanced the state of the art in this technical field, even further improvements remain desirable.

It is against this technological backdrop that the present Applicant sought a technological solution to these and other problems rooted in this technology.

### SUMMARY

In one aspect of the present embodiments there is provided a mobile clean room comprising one or both of a ceiling access and a wall access. One example includes a vertically disposed room frame having an upper and lower portion, a plurality of wall panels affixed between the upper and lower portion of the frame to define an interior space and to form an end wall and front and rear walls, a door hingedly affixed to the frame to form another end wall, a floor panel affixed to the lower portion of the frame, a plurality of wheels affixed to the lower portion of the frame for movably carrying the frame, a dust collection assembly movably attached to the upper portion of the frame and selectively positionable against a ceiling. The wall panels are formed of transparent plastic or polycarb material and the floor panel is formed of an aluminum plate. The dust collection assembly includes a horizontally disposed curtain frame carrying a ceiling seal and defining an access space and a subtending curtain affixed to the curtain frame, the curtain located interiorly of the room frame, the curtain frame being adapted to fit closely adjacent a ceiling surface with the ceiling seal being compressed. One or more wall accesses may be optionally provided in addition to and/or alternatively to a ceiling access.

A pair of spaced hollow guides are attached to the lower portion of the room carrying within a pair of spaced posts subtending from the curtain frame for guided vertical movement of the curtain frame. Locking fasteners are attached between a respective guide and post for selectively securing the post in a desired position.

A ladder is mounted between the upper portion of the room frame and the floor panel. Electrical receptacles are attached to one wall or frame for providing electrical power into the room from an external source of electric power. The floor panel includes an exhaust port therethrough for removing air from the interior space. A vacuum apparatus in the interior space has an outlet removably affixed to the exhaust port.

In another aspect of the present embodiments there is provided a mobile clean room comprising both a ceiling access and a wall access. In accordance with these aspects, one embodiment comprises a vertically disposed room frame having an upper and lower portion, a plurality of wall panels affixed between the upper and lower portions of the frame to define an interior space and to form an end wall and front and rear walls, a door mounted to the frame to form another end wall, a floor panel affixed to the lower portion of the frame, a plurality of wheels affixed to the lower portion of the frame for movably carrying the frame, a ladder disposed in the interior space mounted between the upper portion of the room frame and the floor panel, a dust collection assembly movably attached to the upper portion of said frame. The wall panels are formed of transparent plastic or polycarb material and the floor panel is formed of an aluminum plate. The dust collection assembly includes a horizontally disposed curtain frame defining an access space and a subtending curtain affixed to the curtain frame, the curtain located interiorly of the room frame, the curtain frame being adapted to fit closely adjacent a ceiling surface. A deck is affixed to the upper portion of the room frame mounted between the upper portion of the room frame and the floor panel. Electrical receptacles including a female receptacle attached to the deck are attached to one wall or frame for providing electrical power into the room from an external source of electric power. The floor panel includes an exhaust port therethrough for removing air from the interior space. One or more wall accesses are provided in addition to a ceiling access.

In a further aspect of the present embodiments there is provided a mobile clean room comprising a substantially rectangular frame having an upper and lower portion formed of a plurality of metal tube members, a plurality of transparent plastic wall panels affixed to the frame to form an end wall and front and rear walls, a floor plate affixed to the lower portion of the frame, a plurality of locking swivel wheels affixed to the lower portion of the frame, a ladder mounted between the floor plate and the upper portion of the frame, a dust guard assembly and attachment means for movably mounting the assembly to the upper portion of the frame, a door pivotally mounted to the frame.

In some embodiments, the means for slideably mounting the ladder includes a bracket attached to the upper portion of the room and another bracket attached to the ladder. The brackets form an upwardly facing groove and a downwardly facing groove located with one groove supporting another bracket.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a front view of an example clean work booth in accord with the present embodiments shown without the dust guard assembly and removable vinyl cover;

FIG. 1A illustrates an example for adjusting a working height in accord with some embodiments;

FIG. 2 is a right side view of the booth of FIG. 1;

FIG. 3 is a view of the door used in the booth of FIG. 1;

FIG. 4 is a left side view of the booth of FIG. 1;

FIG. 5 is a top plan view of the floor used in the booth of FIG. 1 with the upper deck shown only pictorially;

FIG. 6 is a top view of the booth of FIG. 1;

FIG. 7 is a top view of the dust guard assembly component used with the booth of FIG. 1;

FIG. 8 is a side view of the dust guard assembly of FIG. 2;

FIG. 9A is a detail of the connection apparatus used for the slideable mounting of the ladder in accord with some embodiments;

FIG. 9B is a detail of the connection apparatus used for mounting the ladder in accord with some embodiments;

FIG. 10 is a partial cross-section of the connection means used for the wall panels and dust collection assembly in accord with the present embodiments;

FIGS. 11A and 11B are drawings of example embodiments having one or more wall accesses; and

FIG. 12 provides drawings of example wall access components according to embodiments.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

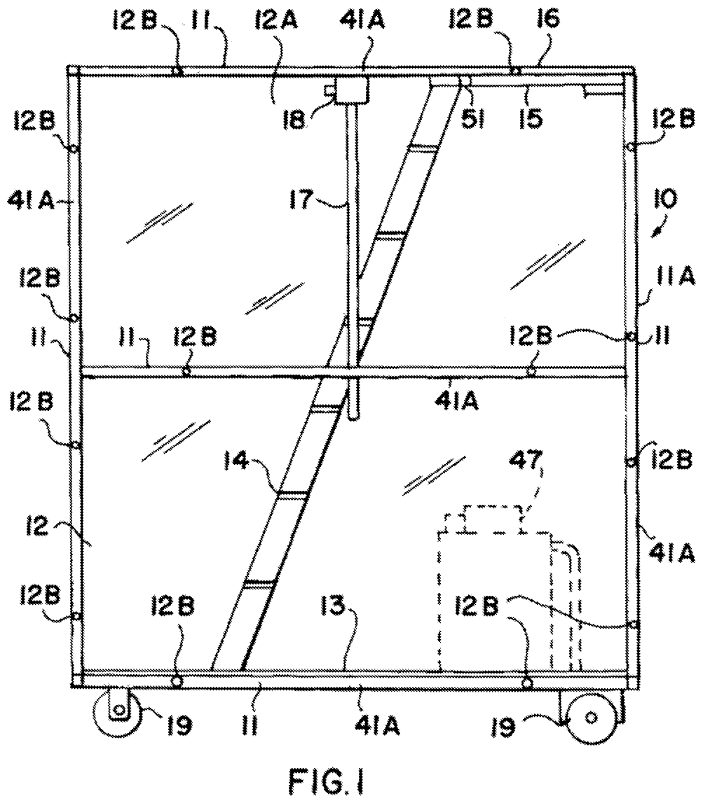

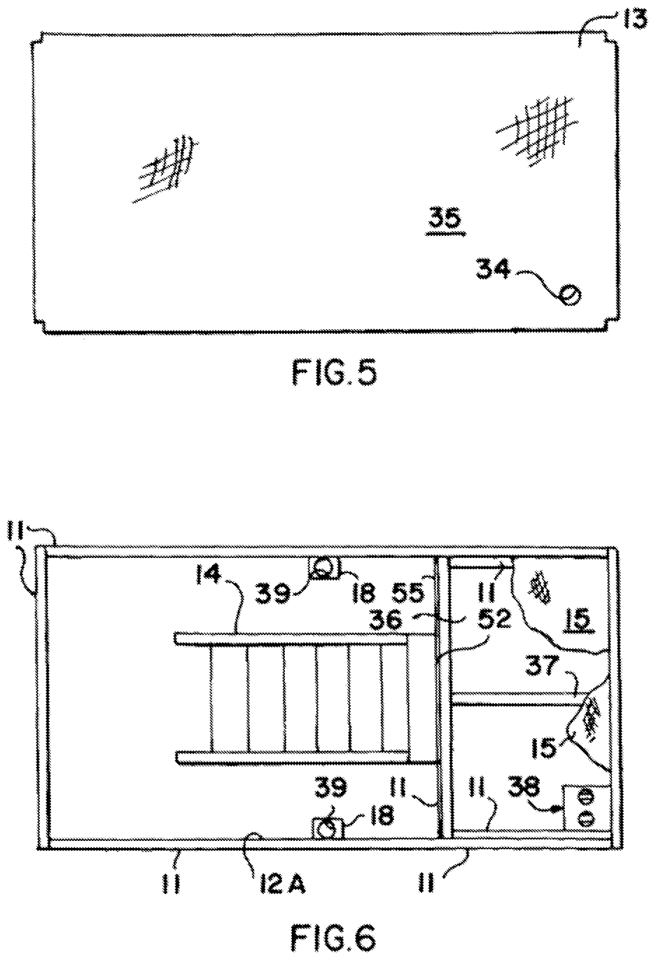

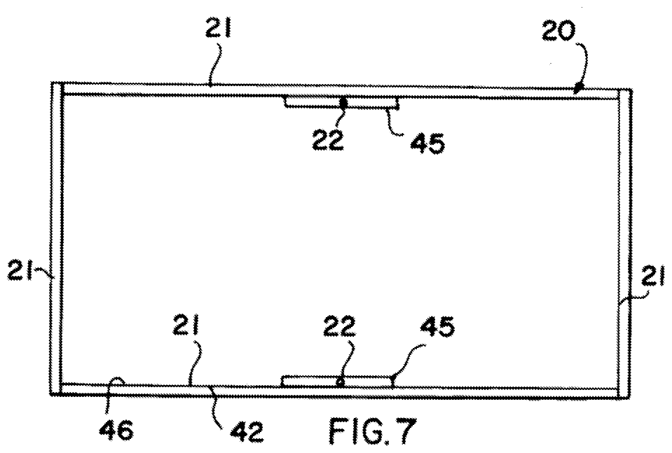

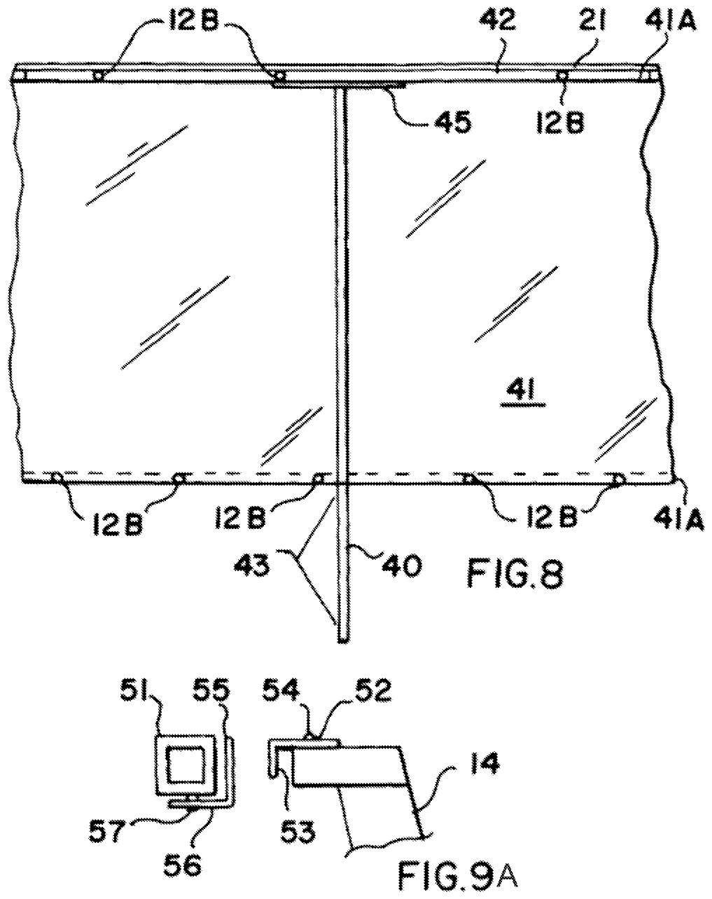

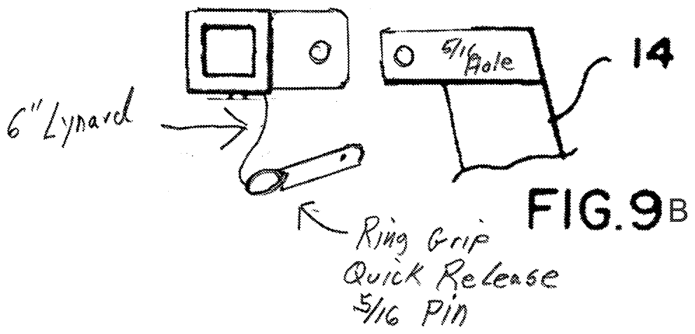

With reference now to the drawings, a front view of the booth or room in accord with the present embodiments is shown at numeral 10 in FIG. 1. A plurality of tubular metal frame members 11 are connected conventionally to form a substantially rectangular frame 11A and onto which a plurality of transparent plastic wall panels 12 formed of heavy (30 mil) vinyl are mounted to define an interior space 12A (FIG. 6). In some alternative embodiments, some or all of wall panels 12 are formed of heavy polycarb clear 0.118 thick material and are attached to frame 11A with high bond SB6467 1″ wide 2-sided tape. A floor 13 (FIG. 5) is a diamond pattern aluminum member to reduce the weight of the room 10. A ladder 14 is mounted inside the booth 10 between floor 13 and a diamond pattern aluminum deck 15 by appropriate brackets or the like. A perimeter foam rubber rim 16 supports the dust guard assembly 20 (FIGS. 7, 8). The booth frame 11 includes a pair of hollow metal guides 17 attached via fasteners 22 (FIG. 7) into which a pair of assembly posts 40 fit and are secured at a desired height via spring-loaded locking washers 18. Booth 10 is supported by four locking swivel wheels 19 for rolling the booth 10 to a desired location.

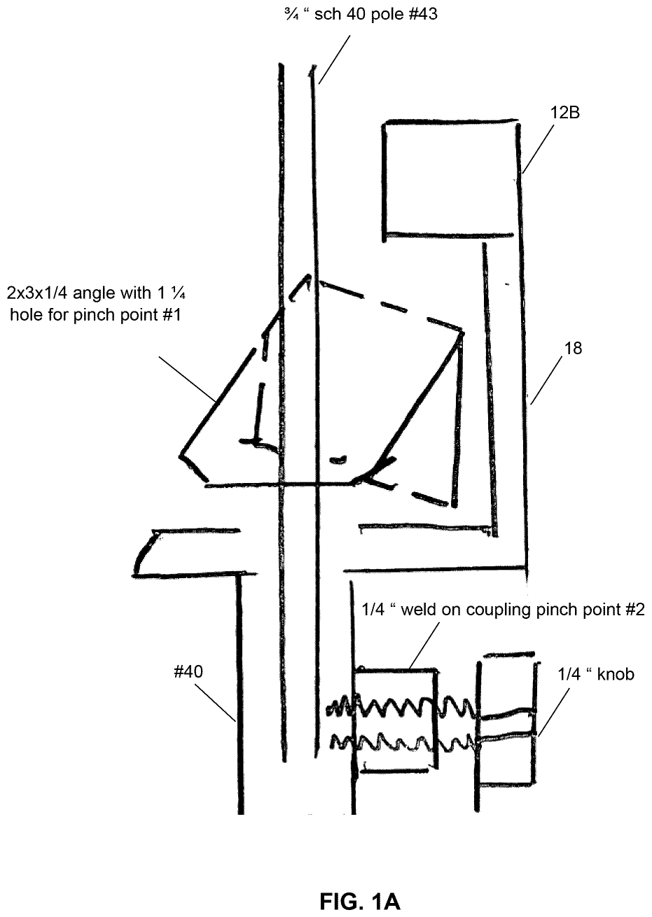

FIG. 2 is a right side view of the booth 10 and shows the dust guard assembly 20 which includes foam rubber seals 21 that rest against a ceiling around ceiling tiles that are to be removed to provide a substantially airtight interface with a ceiling to keep debris inside the room 10.

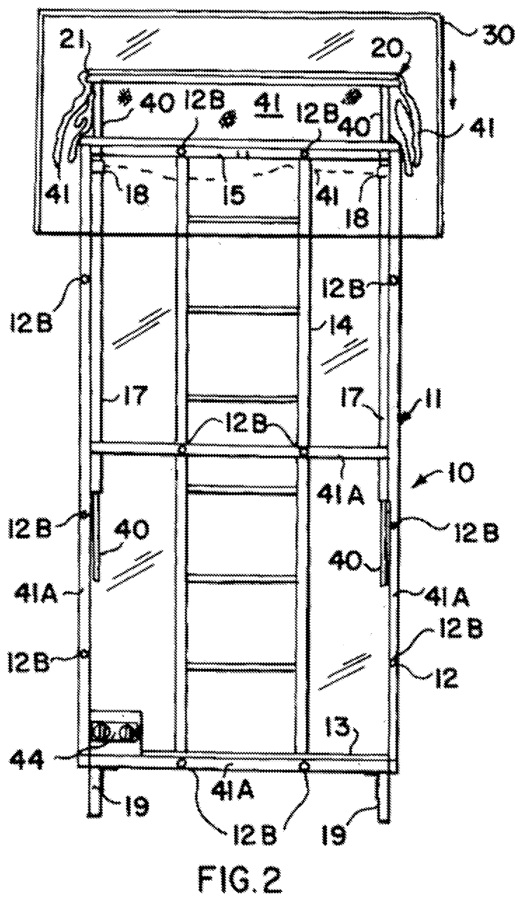

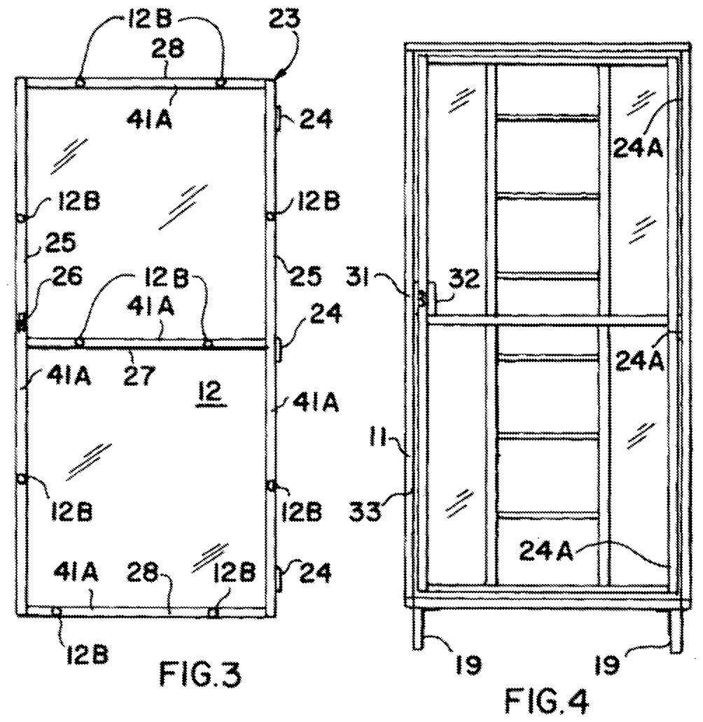

FIGS. 3 and 4 illustrate the door 23 used in the left side of the booth 10. Plastic panel 12 is affixed to door frame members and is the same as before.

Three hinge joints 24, 24A attach door 23 to frame 11. Frame members 25, 27, 28 are metal tubes similar to members 11. Door handle lock assembly 26, 31, 32 is conventional as understood in the art. A fitted transparent vinyl cover or hood 30 is used to cover assembly 20 when the booth 10 is moved or stored (FIG. 2).

Rubber seal 33 is mounted on the frame 11 and not on the door 23.

FIG. 5 illustrates a diamond pattern aluminum plate 35 with exhaust hole 34 used as floor 13.

FIG. 6 illustrates the interior space 39 of locking washers 18 used to control the height of assembly 20. Electrical plugs 38 are interior sources of power and receive power externally from male plugs 44 which are wired to female plugs 38 through a frame member (FIG. 2). Deck 15 is supported on frame members 11 and beam 37 and includes a diamond pattern aluminum plate 36. FIG. 1A illustrates an alterative example for adjusting the height of assembly 20. In this example, two pinch points are provided instead of locking washers 18. One pinch point comprises a 2×3× ¼ angle with a 1-¼ hole. A second pinch point comprises a ¼″ weld on coupling and a ¼″ knob

FIGS. 7 and 8 illustrate the dust guard assembly 20 that includes a rectangular curtain frame 42 defining space 46 covered by foam rubber 21. Guide posts 40 extend downwardly from brackets 45 attached by threaded fastener 22. Guide posts 40 fit in tubes 17 and are longer than guide tubes 17 by the length designated by numeral 43 which provides adequate vertical height adjustment.

FIG. 2 shows, in pictorial fashion, the folding and draping of the curtain 41 partially inside and partially outside frame 11A when dust collection assembly 20 is lowered.

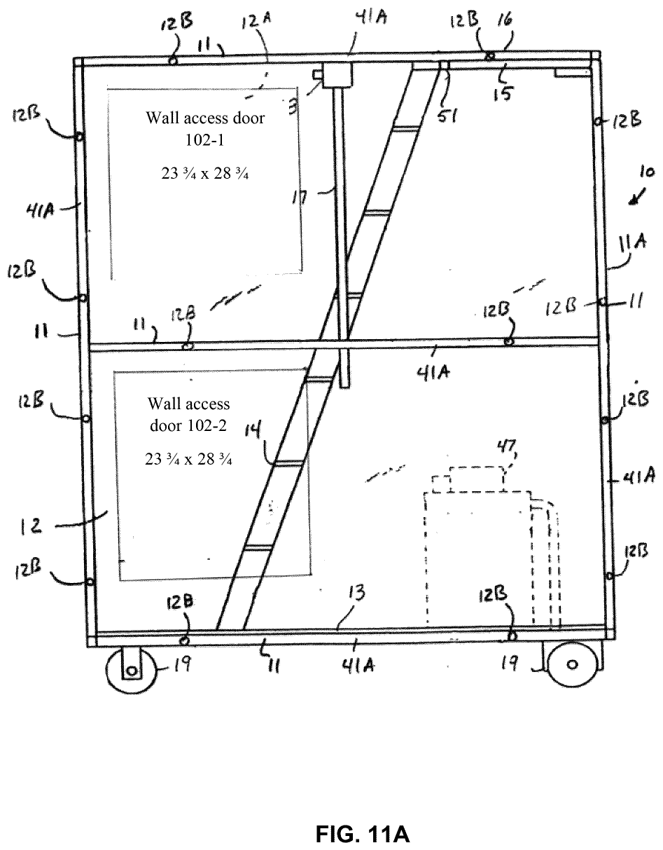

FIG. 10 is a partial cross-section view of further construction details. A vinyl panel 12 is shown attached to a frame member 11 at the top of the lower portion of the room. Spaced rivets 12B connect through frame member 11 and a metal strip 41A and pass through the lower edge of curtain 41 that is also attached to the inside edge of the perimeter of curtain frame 42 component of dust collection assembly 20. Inside the selectively adjustable assembly 20 is an access space to allow a user to access a ceiling. The foam ceiling sealing means 21 is compressed when fitting against a ceiling around an opening therein (FIG. 8). In alternative embodiments, the construction of room 10 involves attaching polycarb material with 3M double sided tape, in which case some or all of rivets 12B are not needed.

The lower portion of room 10 shown in FIG. 1 is approximately 5′10″ high. The maximum vertical height of curtain 41 (FIG. 8) is approximately 4′7″. This sizing allows for the movement of the room 10 in virtually all standard elevators but allows for access to virtually all ceilings at heights even exceeding 10′.

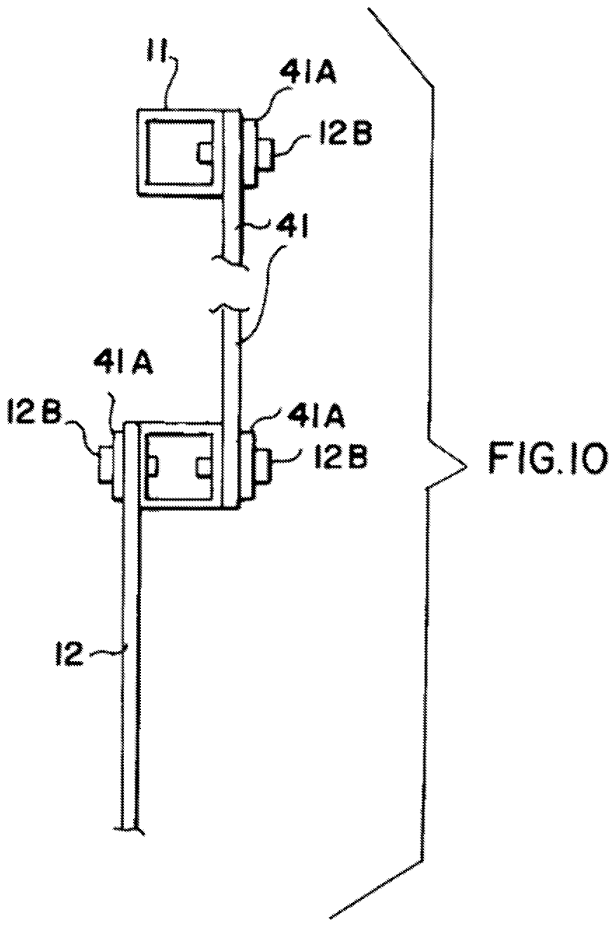

FIG. 9A illustrates one example method of mounting ladder 14 to frame member 51 of upper deck 15. An angle bracket 52 is attached to ladder 14 via bolts 54 or other appropriate means. A downwardly facing groove or recess 53 fits in upwardly facing recess or groove 55 defined by an upstanding portion of an angle bracket 56 bolted to frame member 51 via bolts 57. Ladder 14 is thus slideably mounted to be moved from side-to-side inside room 10 as desired. FIG. 9B illustrates an alternative method of mounting ladder 14 when the ladder 14 is not slideably mounted and/or moveable. In this example, the ladder 14 is mounted using a quick release 5/16″ pin and corresponding 5/16″ holes. The pin can be attached using a ring grip and a 6″ lanyard when not inserted in the holes.

Optional vacuum cleaner 47 includes a HEPA filter and exhausts through exhaust port 34 and is operated to continuously clean the air in the interior space 12A of the room.

In some embodiments, the construction of the room 10 involves mounting vinyl material on the outside of 1″ hollow box members 11. Over the vinyl material, metal strips 41A are placed to sandwich the vinyl material between a strip 41A and an associated frame member 11 via rivets 12B. This particular construction results in defining a plurality of wall panels 12 and door 23. It is to be understood that the three walls could be formed of either a single piece of vinyl or separate vinyl portions as desired in the circumstances. The location, spacing and number of rivets 12B is shown only representatively. In addition, the wall construction details are omitted in FIGS. 6 and 7 for case of illustration.

In alternative embodiments, the construction of room 10 involves attaching polycarb material with 3M double sided tape, in which case some or all of rivets 12B are not needed.

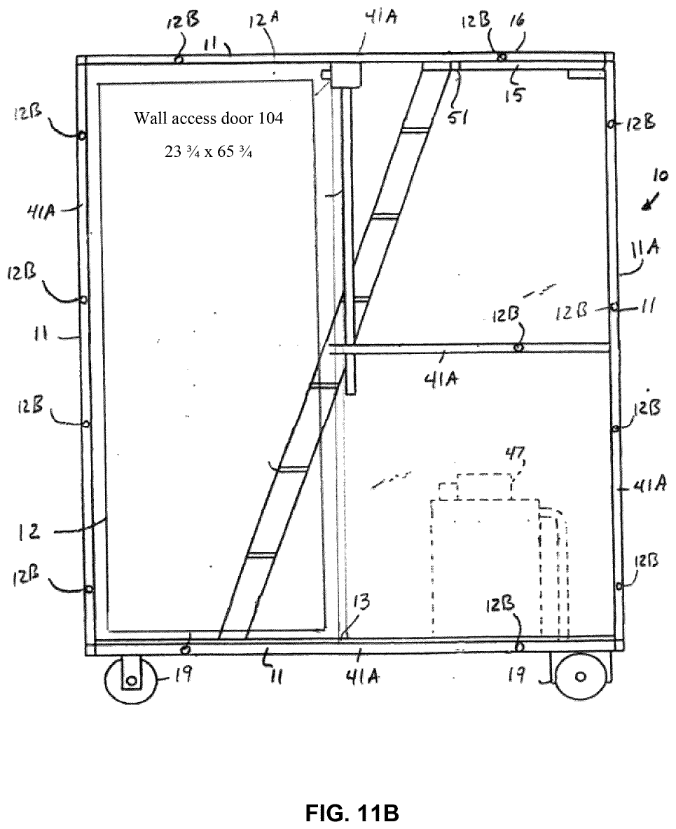

FIG. 11A is a drawing of one example embodiment having two separate wall accesses 102-1 and 102-2 on a side wall of room 10. These wall accesses 102-1 and 102-2 can comprise of doors with frames, windows, sliding assemblies or hinges, etc. In one example, one or both of the accesses 102-1 and 102-2 are formed similar to door 23 and include hinges similar to door 23 and are on a side adjacent to a side of door 23. In other examples, one or both of the accesses 102-1 and 102-2 are hatches with frames, in which case the hatches are coupled to the frames with a friction fit, latches, etc. In other examples, one or both of the accesses 102-1 and 102-2 are sliding windows with frames/tracks. Many other alternatives are possible.

FIG. 11B is a drawing of one example embodiments having a wall access 104 that extends substantially completely from a top end to a bottom end of the booth. This wall access 104 can comprise of a door with a frames, a window, sliding assemblies or hinges, etc. In one example, access 104 is formed similar to door 23 and include hinges similar to door 23 and is on a side adjacent to a side of door 23. In other examples, accesses 104 is a hatches with a corresponding frame, in which case the hatch is coupled to the frame with a friction fit, latches, etc. In other examples, access 104 is a sliding door with frames/tracks. Many other alternatives are possible.

It should be apparent that any combination of accesses 102 and/or 104 may be provided in a given room according to embodiments. For example, one room may only include one or two accesses 102 and no accesses 104. Another room may include one or two accesses 102 on one side, and one access 104 on another side. Another room may include more than two accesses 102 on more than one side, and one access 104 on another side. As another example, one room may only include one or two accesses 104 and no accesses 102. Another room may include one or two accesses 104 on corresponding sides, and one or more accesses 102 on another side. Another room may include more than two accesses 104 on more than one side, and one access 102 on another side.

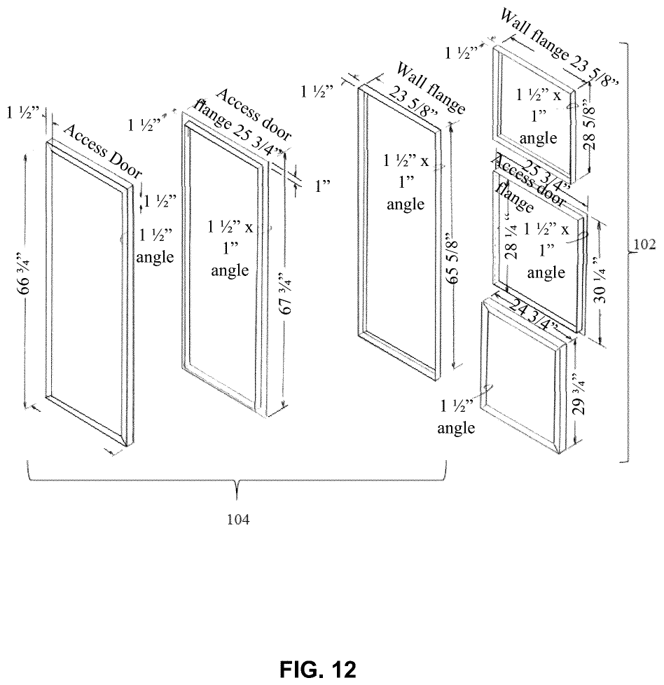

FIG. 12 are drawings of example wall access components 102 and 104 according to embodiments. In these illustrated embodiments, accesses 102 and 104 comprise hatches with corresponding flange components, in which case the hatches are held within the frames with a friction fit, latches etc.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A mobile clean room comprising a wall access or both of a ceiling access and the wall access.

2. The mobile clean room of claim 1, further comprising a vertically disposed rectangular room frame having an upper and lower portion, a plurality of wall panels affixed between said upper and lower portion of said frame to define an interior space and to form an end wall and front and rear walls, a vertically elongated rectangular door hingedly affixed to said frame solely forming another end wall of said room, a floor panel affixed to said lower portion of said frame, a plurality of wheels affixed to said lower portion of said frame closely adjacent said floor panel for movably carrying said frame, a dust collection assembly movably attached to said upper portion of said frame and selectively positionable vertically against a ceiling, said wall panels and said door being formed of non-load bearing transparent plastic material to enable substantially unobstructed visibility through said room; said dust collection assembly including a horizontally disposed rectangular curtain frame carrying a coextensive rectangular ceiling seal and defining an access space and a subtending curtain affixed to said curtain frame, said curtain being located interiorly of and being connected to said room frame, said curtain frame being lowerable and raiseable vertically to fit closely adjacent a ceiling surface with said ceiling seal being compressed, only one pair of spaced hollow guides within said interior space attached to said upper portion of said room frame, only one pair of spaced posts subtending from said curtain frame and located to fit within a corresponding said guide and being movable vertically therein by a user from within said room, (1) first and second pinch points or (2) one pair of spaced locking fasteners attached between said guide and respective said post to selectively secure each said post in a desired position with said ceiling seal compressed.

3. The room as defined in claim 2 wherein said wheels are lockable and swiveling.

4. The room as defined in claim 2 further including a ladder mounted between said side walls, said ladder being supported at its lower end by said floor panel.

5. The room as defined in claim 2 further including an electrical receptacle attached outwardly of and to said room frame for providing electrical power into said room from an external source of electric power.

6. The room as defined in claim 2 further including a vacuum apparatus in said interior space, said floor panel including an exhaust port therethrough for exhausting air from said interior space to beneath said floor panel, said vacuum apparatus having an outlet communicating with said exhaust port to collect debris in said apparatus and exhaust filtered air therefrom and out said exhaust port.

7. The room as defined in claim 2 further including a rectangular deck mounted to said frame closely adjacent to and below said rectangular curtain frame and extending between said side walls and said end wall and being supported by said frame forming said walls.

8. The room as defined in claim 2 further including one or more of the wall accesses.

9. A mobile clean room comprising both of a ceiling access and a wall access.

10. The mobile clean room of claim 9, further comprising a vertically disposed rectangular room frame having an upper and a lower portion, a plurality of wall panels affixed between said upper and lower portions of said frame to define an interior space and to form an end wall and front and rear walls, a door hingedly mounted to said frame and alone forming another end wall oppositely disposed from said end wall, a floor panel affixed to said lower portion of said frame, a plurality of wheels affixed to said lower portion of said frame closely adjacent said floor panel for movably carrying said frame, a ladder disposed in said interior space located between said upper portion of said room frame and said floor panel, a vacuum apparatus in said interior space having an outlet, said floor panel includes an exhaust port therethrough for removing filtered air exiting said outlet while retaining debris within said room, and a dust collection assembly movably attached to said upper portion of said frame, said dust collection assembly including a horizontally disposed rectangular curtain frame defining an access space and a subtending curtain affixed to said curtain frame and to said room frame, said curtain being located interiorly of said room frame, said curtain frame including a compressible seal extending along the entire said curtain frame and above said curtain frame and adapted to fit closely and compressed adjacent a ceiling surface.

11. The room as defined in claim 10 wherein said wall panels are formed of transparent polycarb material and attached with double sided tape.

12. The room as defined in claim 10 wherein said ladder is mounted to said upper portion of said frame between said front and rear walls with a removable pin in corresponding holes.

13. The room as defined in claim 10 further including a deck affixed to said upper portion of said room frame spacedly remote from said floor panel and closely adjacent said rectangular curtain frame.

14. The room as defined in claim 10 further including an electrical female receptacle attached to said deck into which a user of said room may plug tools therein.

15. The room as defined in claim 14 further including an electrical male receptacle attached to said room frame for providing electrical power into said room to said female receptacle from an external source of electric power.

16. The room as defined in claim 10 wherein said wheels are swivelable for allowing rolling movement of said room in a plurality of directions and are lockable to inhibit movement of said room.

17. The room as defined in claim 10 further including a bracket attached to said upper portion of said room and another bracket attached to said ladder.

18. The room as defined in claim 10 wherein said dust collection assembly includes a pair of spaced hollow guides attached to said upper portion of said room frame, a pair of spaced posts attached to said curtain frame respectively adjacent respective front and rear walls, said pair of posts respectively located within respective said guides and movable vertically therein by a user from within said room, a pair of locking fasteners attached between respective said guides and said posts therein to selectively secure each said post in its upper position with said ceiling seal compressed.

19. The room as defined in claim 10, further comprising one or more of the wall accesses.
